(19) United States
(12) Patent Application Publication
(10) Pub. No.: US 2018/0295513 A1
(43) Pub. Date: Oct. 11, 2018

(54) AUTHENTICATION SYSTEM USING NFC TAGS

(71) Applicant: Walmart Apollo, LLC, Bentonville, AR (US)

(72) Inventors: Kellie Embree, Bentonville, AR (US); Richard Andrew White, Pineville, MO (US); Jimmie Russell Clark, Fayetteville, AR (US)

(21) Appl. No.: 15/946,333

(22) Filed: Apr. 5, 2018

Related U.S. Application Data
(60) Provisional application No. 62/482,479, filed on Apr. 6, 2017.

(51) Int. Cl. H04W 12/06; H04W 4/80; H04B 5/00; H04L 29/06

(52) U.S. Cl. CPC H04W 12/06; H04L 63/0846; H04B 5/0056; H04W 4/80

(57) ABSTRACT

Exemplary embodiments provide an authentication system for granting access to an access point. The system includes a Near-Field-Communication (NFC) tag, a NFC reader and writer, and an access point coupled to the NFC reader and writer. The NFC reader and writer is configured to read the NFC tag when the access point is activated and the NFC tag is within range of the NFC reader and writer. In a first phase of authentication, the NFC reader and writer is configured to read and analyze data stored in the memory of the NFC tag to authenticate access to the access point. In a second phase of authentication, the access point is configured to receive and analyze a user input, and grant access to the access point based on analyze of the user input and success at the first phase of authentication.

### RELATED APPLICATION

This application claims priority to U.S. Provisional Application No. 62/482,479 filed on Apr. 6, 2017, the contents of which is hereby incorporated by reference in its entirety.

### BACKGROUND

Businesses and organizations need a method for granting access and authenticating access to various devices and networks. Conventionally, businesses and organizations use RSA SecurID® tokens, for example, to grant a user access to a device or network.

### SUMMARY

In one embodiment, an authentication system is provided for granting access to an access point. The system includes a Near-Field-Communication (NFC) tag with a memory, a NFC reader and writer, and an access point coupled to the NFC reader and writer. The NFC reader and writer is configured to read the NFC tag when the access point is activated. The NFC tag is configured for bisynchronous communication when it is within a defined physical range of the NFC reader and writer. In a first phase of authentication, the NFC reader and writer is configured to read data stored in the memory of the NFC tag and analyze the data to authenticate access to the access point. In a second phase of authentication, the access point is configured to receive and analyze a user input, and grant access to the access point based on the analysis of the user input at the access point and success of the first phase of authentication.

In another embodiment, a method for authenticating access to an access point is provided. The method includes storing data in a memory of a NFC tag, where the NFC tag is configured for bisynchronous communication when it is within a defined physical range of a NFC reader and writer coupled to an access point. In a first phase of authentication, the method includes reading, via the NFC reader and writer, the data in the NFC tag when the access point is activated, and analyzing the data to authenticate access to the access point. In a second phase of authentication, the method includes receiving a user input at the access point, analyzing the user input at the access point, and granting access to the access point based on the analysis of the user input and success of the first phase of authentication.

In yet another embodiment, a non-transitory computer readable medium is provided that stores instructions that when executed by a processor causes the processor to implement a method for authenticating access to an access point is provided. The method includes storing data in a memory of a NFC tag, where the NFC tag is configured for bisynchronous communication when it is within a defined physical range of a NFC reader and writer coupled to an access point. In a first phase of authentication, the method includes reading, via the NFC reader and writer, the data in the NFC tag when the access point is activated, and analyzing the data to authenticate access to the access point. In a second phase of authentication, the method includes receiving a user input at the access point, analyzing the user input at the access point, and granting access to the access point based on the analysis of the user input and success of the first phase of authentication.

### BRIEF DESCRIPTION OF THE DRAWINGS

The accompanying drawings, which are incorporated in and constitute a part of this specification, illustrate one or more embodiments of the present invention and, together with the description, help to explain the present invention. The embodiments are illustrated by way of example and should not be construed to limit the present invention. In the drawings:

FIG. 1A is a block diagram of an authentication system, according to an example embodiment;

FIG. 1B is block diagram of an exemplary NFC reader/writer, according to an example embodiment;

FIG. 2 is a block diagram showing an exemplary authentication system, according to an example embodiment;

FIG. 3 is a flowchart illustrating an exemplary method for authenticating access to a terminal or an access point, according to an example embodiment;

FIG. 4 is a flowchart for using an authentication system, according to an example embodiment;

FIG. 5 is a diagram of an exemplary network environment suitable for a distributed implementation of exemplary embodiments; and

FIG. 6 is a block diagram of an exemplary computing device that may be used to implement exemplary embodiments described herein.

### DETAILED DESCRIPTION

Businesses or organizations often use RSA SecurID® tokens for authentication. RSA SecurID® tokens or other like tokens allow a user to access a network resource of the business or organization. These tokens can be expensive, and may not be cost efficient for granting access to third-party vendors who do not access the business or organization resources daily or on a regular basis. The third-party vendors may not even use the token or they are prone to losing the token. The RSA SecurID® tokens may be suitable for use by employees to access network resources remotely (from outside of the business or organization). However, if the RSA SecurID® token is not reclaimed or returned, the user (employee or third-party vendor) may still be able to access network resources remotely.

Exemplary embodiments of the authentication system described herein provides a low cost Radio Frequency (RF) tag for performing two-factor authentication for a user to access an access point or a terminal. Exemplary embodiments of the authentication system grants a user access to a terminal or an access point when the user (RF tag) is physically within range of the terminal or the access point. Additionally, the authentication system described herein is capable of granting user access to a terminal or an access point without the use of the industry-known Lightweight Directory Access Protocol (LDAP), or without accessing a server of the business or organization. As such, if the business or organization network or server is disabled or unavailable, the authentication system described herein can still grant a user access to a terminal or an access point. Moreover, since LDAP is not used, the authentication process is more efficient in terms of time and resources. In a non-limiting embodiment, the RF tag is a Near Field Communication (NFC) tag.

Exemplary embodiments of the authentication system include a bisynchronous NFC tag used for two-phase authentication. In some embodiments, the NFC tag is more secure than traditional radio frequency (RF) technology as the NFC tag can only engage in peer-to-peer communications. That is, the NFC tag can only communicate with one other NFC device (for example, a RF reader/writer, such as an NFC reader/writer) at a time, which ensures that no other device can take control of communications or the authentication process. The NFC tag includes one or more small antennas, which requires the NFC tag to be on the correct wavelength to communicate with the NFC reader/writer, and also requires the NFC tag to be within a few inches of the NFC reader/writer for the authentication process.

In an example two-phase authentication, a user scans his or her NFC tag at or near the terminal or the access point. After that, the user is prompted to enter a password, passcode or PIN. Based on the reading of the NFC tag and the user inputted password, the authentication system grants the user access to the terminal or the access point. In an example embodiment, the terminal or the access point may also prompt the user to answer one of many security questions prior to granting the user access to the terminal or the access point.

The NFC tag can also be dynamically locked or disabled in real-time if the NFC tag is lost or stolen, or if access rights for a user need to be revoked.

An access point or a terminal, as used herein, refers to a computing device, a data center that includes a large number of networked computers, a server or a server cluster, and the like. The authentication system described herein grants a user access to a physical terminal or an access point when the user is physically near the terminal or the access point.

An NFC tag includes a memory and an antenna. In an example embodiment, the NFC tag is configured for bisynchronous communications, that is, the NFC tag is capable of being read and written to at the same time. In some embodiments, the NFC tag is embedded in a card or badge that a user carries with him or her or in a wearable device that the user wears. The memory of the NFC tag stores data, such as, a user ID, a password, a PIN, one or more security questions, and other authenticating data. The memory of the NFC tag may also store data indicating the number of times the NFC tag has been used, the number of times the NFC tag is authorized to be used, an expiration date for access, Media Access Control (MAC) address lockdown (that can constrain the user to a unique piece of hardware based on the MAC address), and other data related to the use of the NFC tag. In an example embodiment, the memory of the NFC tag may also include data often stored in LDAP, such as, user information, user group information, device access information, printer access information, and the like.

The NFC tag is a passive electronic device. Passive electronic devices require an electrical current to operate, but do not include an electrical source within the device itself to produce electrical current. Passive devices use an external source of energy to generate the current that they consume. In an example embodiment, the RF tag can be powered by radio frequency waves transmitted from the RF reader/writer. For example, as a non-limiting example, when the type of RF tag is an NFC tag, embodiments of the NFC tag described herein uses an ultra-high frequency radio wave transmitted by the NFC reader/writer as the external source of energy. In an example embodiment, the NFC tag may be a non-internally powered badge, security fob, security token, or chip.

An RF reader/writer (e.g., a type of RF reader/writer is an NFC reader/writer) may also be referred to as an RF reader and writer, and is configured to read data stored in a RF tag (e.g., a type of RF tag is an NFC tag) and write data to the RF tag (e.g., NFC tag). In an example embodiment, the RF reader/writer reads and writes data to the RF tag concurrently or at the same time. The RF reader/writer may include a memory and an antenna. The RF reader/writer may read the data in the memory of the RF tag when the RF tag is within a readable range of the RF reader/writer. In an example embodiment, for embodiments in which the RF tag is an NFC tag, the readable range of the NFC tag is within approximately 6 inches of the NFC reader/writer.

For embodiments in which the RF reader/writer is an NFC reader/writer configured to communicate with an NFC tag, the NFC reader/writer is an NFC enabled device configured to read information stored on NFC tags and write information to the NFC tags. In some embodiments, the NFC reader/writer is configured to support data encryption, comply with standards published by the International Organization for Standardization (ISO) and International Electrotechnical Commission (IEC), and support other authentication methods. As a non-limiting example, the NFC reader/writer may be a commercially available device NFC Reader SL600 sold by Stronglink Technology Co., Ltd.

In some embodiments, the RF reader/writer may be included in a smartphone, tablet, laptop or other computing devices as an internal component. In other embodiments, the RF reader/writer may also be connected to the terminal or access point as a peripheral device. The host processor at the computing device, terminal or access point (the device that includes the RF reader/writer within itself or as a peripheral device) is enabled to accept input at the RF reader/writer and output (write) data to the RF tag in a bisynchronous manner. In the authentication system described herein, the input and output from the RF reader/writer is the method for data entry and data output. The RF reader/writer generates radio waves that are received by the RF tag's antenna. The received waves are converted into electrical energy that powers the RF tag's electronic circuitry and enables the logic stored on the RF tag to execute. The logic stored on the RF tag includes digital logic and software code used by the authentication system to perform certain functionalities described herein. When access is authenticated and is granted or denied, the electronic circuitry in the RF tag sends the data (access granted or denied) back to the RF reader/writer. In response to access being granted, software code on the host processor is executed and enables the user access to the terminal or access point. A message is generated by the host processor and sent to the RF tag and stored on the RF tag. The authentication transaction is completed, and the output data remains stored on the RF tag.

In some embodiments, a user may need to re-authenticate access to the terminal or the access point after a brief period of time (for example, every few minutes) to have continued access to the terminal or the access point.

In some embodiments, access to the terminal or the access point also enables a user to access other devices on the same network as the terminal or access point. In other embodiments, a user is limited to access to the terminal or the access point, and is unable to access other devices on the network.

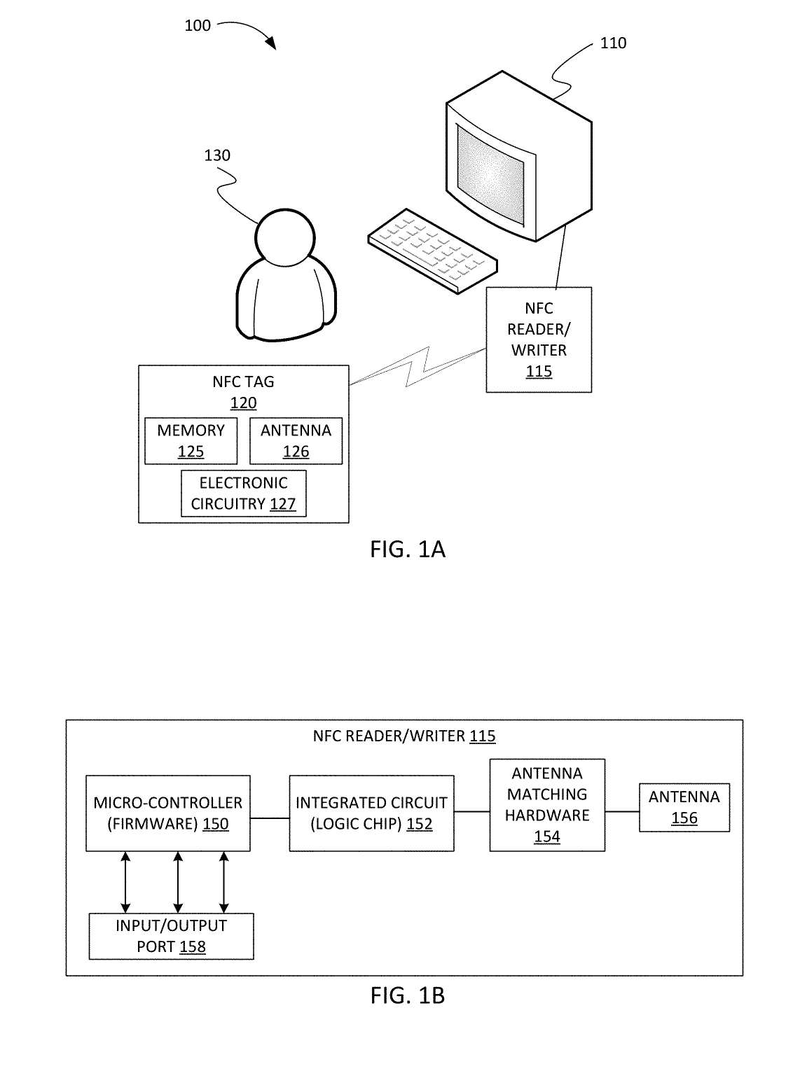

FIG. 1A is a block diagram of an authentication system 100, according to an example embodiment. The authentication system 100 includes a terminal or an access point 110, and a NFC reader/writer 115 (e.g., an RF reader/writer) coupled to the terminal or access point 110. In some embodiments, the NFC reader/writer 115 is embedded in the terminal or the access point 110. The authentication system 100 also includes an NFC tag 120 (e.g., an RF tag) that a user 130 may carry or wear. The NFC tag 120 includes a memory 125, an antenna 126, and electronic circuitry 127. The antenna 126 may be a short-range antenna to facilitate communication with the NFC reader/writer 115 at a specified frequency. The electronic circuitry 127 includes digital logic circuits and memory storing software code that facilitates authentication of a user to grant access to the terminal or access point 110. The NFC reader/writer 115 is configured to read data in the memory 125 of the NFC tag 120, write data to the memory 125 of the NFC tag 120, or perform both tasks at the same time. The NFC reader/writer 115 can read or write to the NFC tag 120 when it is within range of the NFC reader/writer 115. In an example embodiment, an acceptable range for reading or writing to the NFC tag 120 is 6 inches to 0 inches from the NFC reader/writer 115. In another embodiment, the an acceptable range for reading or writing to the NFC tag 120 is 10 inches to 0 inches from the NFC reader/writer 115. In some embodiments, the NFC reader/writer 115 communicates with the NFC tag 120 using ultra-high frequency radio waves. The NFC reader/writer 115 transmits radio waves to the NFC tag 120, which powers the electronic circuitry 127 of the NFC tag 120.

FIG. 1B is a block diagram of an exemplary NFC reader/writer 115. As shown in the figure, the NFC reader/writer 115 includes a micro-controller 150, an electronic circuitry 152 (as known as a logic chip), an antenna matching hardware 154, an antenna 156, and an input/output port 158. The input/output port 158 receives via the antenna 156 inputs, for example, data or signals from the NFC tag 120, and outputs via the antenna 156, for example, data or signals to the NFC tag 120. The input/output port 158 may also receive input and provide output to the terminal or access point 110. The microcontroller 150 includes one or more CPUs (processor cores) along with memory and programmable input/output peripherals, and digital circuitry to execute firmware that can provide a layer of security, such as data encryption and the like. The electronic circuitry 152 and the antenna matching hardware 154 includes digital logic circuitry or software code that enables the NFC reader/writer 115 to read data from and write data to the NFC tag 120. The antenna matching hardware 154 is compatible with the antenna 156 included in the NFC reader/writer 115. The antenna 156 is compatible with the antenna 126 of the NFC tag 120 to enable the NFC reader/writer 115 to read from and write to the NFC tag 120. That is, the antenna 156 and the antenna 126 match in wave or signal frequency. The NFC reader/writer 115 may communicate with the NFC tag 120 via a specified frequency. Additional security measures may be provided externally to the NFC reader/writer 115, for example, at the NFC tag 120 or the terminal/access point 110.

The NFC tag 115 is a type of RF tag and the NFC reader/writer is a type of RF reader/writer. RF tags can be configured to transmit and receive RF communications at one or more frequencies, and RF readers/writers can be configured to transmit and receive RF communications at one or more frequencies.

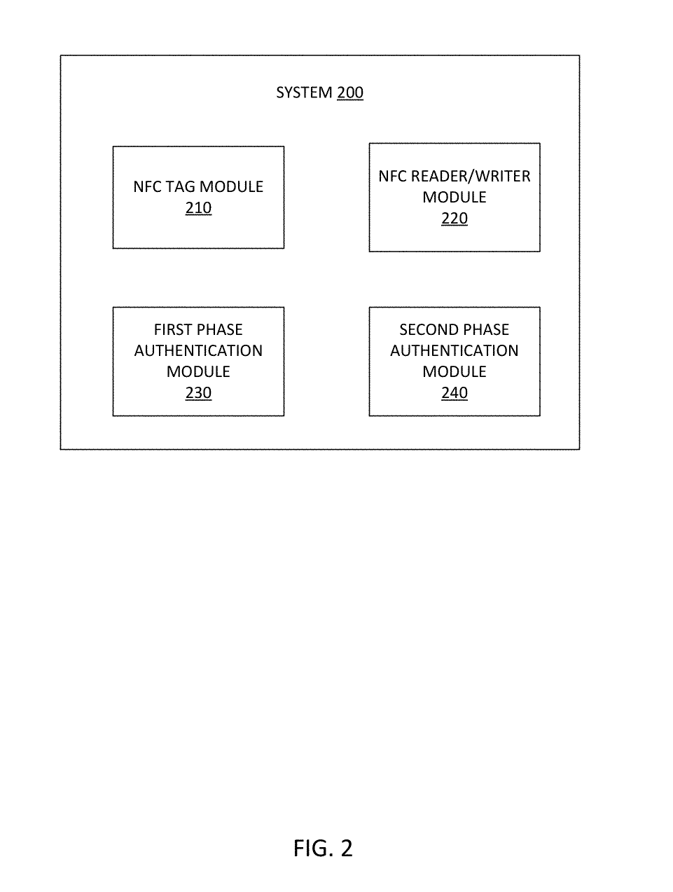

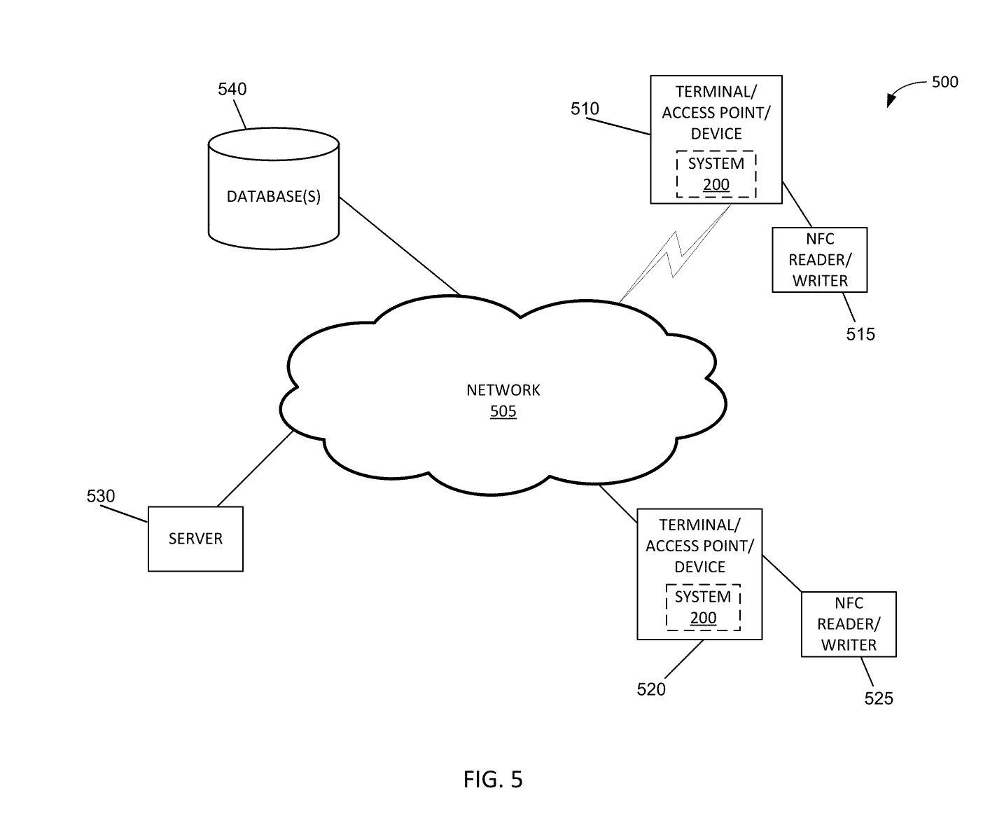

FIG. 2 is a block diagram showing a system 200 in terms of modules for granting access to a terminal or an access point, according to an example embodiment. The modules include an NFC tag module 210 (e.g., an RF tag module), an NFC reader/writer module 220 (e.g., an RF reader/writer module), a first phase authentication module 230, and a second phase authentication module 240. The modules may include various circuits, circuitry and one or more software components, programs, applications, or other units of code base or instructions configured to be executed by one or more processors (e.g., processors included in a terminal/access point/device 510 or a terminal/access point/device 520 shown in FIG. 5). In an example embodiment, one or more of modules 210, 220, 230, 240 is included in a terminal, an access point, or a device (e.g., terminal/access point/device 510 or terminal/access point/device 520 shown in FIG. 5). In another embodiment, one or more of the modules 210, 220, 230, 240 may be included in a RF reader/writer (e.g., NFC reader/writer 515 or NFC reader/writer 525 shown in FIG. 5). Although modules 210, 220, 230, 240 are shown as distinct modules in FIG. 1, it should be understood that modules 210, 220, 230, and 240 may be implemented as fewer or more modules than illustrated. It should be understood that one or more of modules 210, 220, 230, and 240 may communicate with one or more components included in exemplary embodiments of the present disclosure (e.g., terminal/access point/device 510, NFC reader/writer 515, terminal/access point/device 520, NFC reader/writer 525, server 530, or database(s) 540 of system 500 shown in FIG. 5).

The NFC tag module 210 may be a hardware-implemented module configured to manage and maintain NFC tag data. For example, the NFC tag module 210 may manage and maintain a list of NFC tags corresponding to users using a tag id and a user id.

The NFC reader/writer module 220 may be a hardware-implemented module configured to manage and maintain NFC reader/writer data. For example, the NFC reader/writer module 220 may manage and maintain a list of NFC reader/writer corresponding to terminals and access points using an NFC reader/writer id and a terminal id or an access point id. The NFC reader/writer module 220 may also be configured to write data to the NFC tag 120 to dynamically revoke access rights or to disable a NFC tag.

The first phase authentication module 230 may be a hardware-implemented module configured to read the NFC tag when the tag is within range of the NFC reader/writer and when the terminal or access point is activated. A user may activate the terminal or the access point by turning the terminal or access point on or waking it from sleep mode. The first phase authentication module 230 may match the data read from the NFC tag to data stored at the terminal/access point or the NFC reader/writer.

The second phase authentication module 240 may be a hardware-implemented module configured to receive user input via the terminal or the access point and match the user input to data stored in the NFC tag or data stored at the terminal/access point or the NFC reader/writer.

The NFC tag 115 is a type of RF tag and the NFC reader/writer is a type of RF reader/writer. RF tags can be configured to transmit and receive RF communications at one or more frequencies, and RF readers/writers can be configured to transmit and receive RF communications at one or more frequencies.

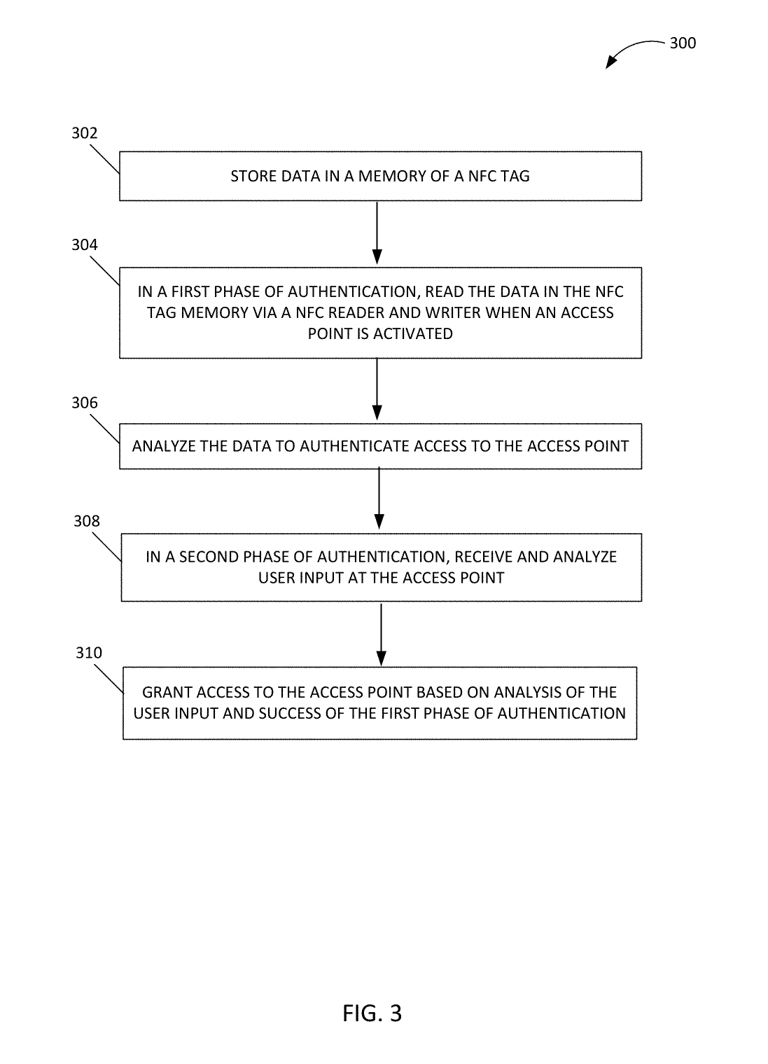

FIG. 3 is a flowchart illustrating an exemplary method 300 for authenticating access to a terminal or an access point, according to an example embodiment. The method 300 may be performed using one or more modules of the system 200 described above.

At step 302, the NFC tag module 210 stores data in the memory 125 of the NFC tag 120. As described above, the NFC tag 120 is configured for bisynchronous communication when it is within range of the NFC reader/writer 115. The NFC reader/writer 115 is coupled to the terminal or access point 110. In an example embodiment, the NFC tag module 210 stores a user identification code and an authentication passcode in the memory 125 of the NFC tag 120 that is read by the NFC reader and writer 115 to authenticate access to the terminal or the access point 110 in the first phase of authentication.

At step 304, in the first phase of authentication, the first phase authentication module 230 reads the data in the memory 125 of the NFC tag 120 via the NFC reader/writer 115. The first phase authentication module 230 reads the data from the NFC tag 120 when the terminal or the access point 110 is activated and when the NFC tag 120 is within a defined range of the NFC reader/writer 115. A user may activate the terminal or the access point by turning the terminal or access point on, or by waking it from sleep mode.

At step 306, the first phase authentication module 230 analyzes the data read at step 304. The first phase authentication module 230 determines whether access should be granted to the terminal or the access point. In some cases, the NFC tag 120 scanned by the NFC reader/writer 115 may not be a valid security NFC tag that is programmed to grant a user access to the terminal or access point within the particular facility or organization. For example, the NFC tag may be library card, a security badge for another organization or facility, a NFC tag attached to merchandise or some other NFC tag that is not a security NFC tag for the particular facility or organization. At step 306, the NFC reader/writer 115 analyzes the data to verify the validity of the NFC tag 120 as a known security NFC tag 120.

At step 308, in the second phase of authentication, the second phase authentication module 240 receives user input at the terminal or the access point 110. The second phase authentication module 240 analyzes the user input. In an example embodiment, the second phase authentication module 240 compares the user input to data stored in the NFC tag 120, and if there is a match, then the second phase of authentication is successful. In another embodiment, the second phase authentication module 240 compares the user input to data stored at the terminal or the access point 110 or the NFC reader/writer 115, and if there is a match, then the second phase of authentication is successful.

At step 310, the second phase authentication module 230 grants access to the terminal or the access point 110 based on the analysis of the user input at step 308 and successful authentication in the first phase of authentication at step 306. In this manner, the authentication system described herein provides a user access to a terminal or an access point via two-phase authentication when the user is within physical range of the terminal or the access point.

In an example embodiment, the NFC reader/writer 115 transmits ultra-high frequency radio waves to the NFC tag 120. The electronic circuitry 127 of the NFC tag 120 reads the data stored in memory 125 and executes logic or software code to facilitate user authentication. The user enters input at the terminal or access point 110 for authentication. If the original or primary security system of the terminal or access point is available, the security system performs the second phase of authentication. The original or primary security system may be an LDAP system that includes user access information for particular users. If the original or primary security system is not available, then the second phase of authentication is performed by reading data in the NFC tag 120. In an example embodiment, the NFC tag 120 includes a scaled-down LDAP tree, and the second phase of authentication is performed using the scaled-down LDAP tree on the NFC tag 120. The scaled-down LDAP tree only includes user access information for the user associated with the NFC tag, rather than including user access information for all users of the facility or organization. In the case where the LDAP system is unavailable, the user can still gain access to the terminal or access point by using the scaled-down LDAP tree stored in the NFC tag. User access information stored in the LDAP system or the scaled-down LDAP tree may define access to databases, files, file shares, hardware, computing devices, network drives, secured doors, and the like. The memory 125 of the NFC tag 120 may include personal security question, corresponding personal security answers, a scaled-down LDAP tree, and other security information as needed.

In an example embodiment, the NFC tag module 210 stores in the memory of the NFC tag a period of time for which the user identification code and the authentication code are valid. The user 130 is denied access to the terminal or the access point 110 after the period of time stored in the NFC tag 120 expires. The first authentication phase module 230 may read data from the NFC tag 120 indicating the period of time, and determine whether the period of time has expired. If the period is expired, then the first phase of authentication fails.

In an example embodiment, the NFC reader/writer 115 writes data to the NFC tag 120 representing a number of unsuccessful attempts, a number of successful attempts, and/or an expiration date to the memory 115 of the NFC tag 120. The NFC reader/writer 115 actively writes such data to the NFC tag 120 based on an authentication attempt to access the terminal or the access point 110 when the NFC tag is within range of the NFC reader/writer 115. In an example embodiment, when the NFC reader/writer 115 determines that the number of unsuccessful attempts exceeds a predefined number, the NFC reader/writer 115, in response, erases the data in the NFC tag memory 125 and disables the NFC tag 120. The NFC reader/writer 115 erases the data when the NFC tag 120 is within range of the NFC reader/writer 115.

In an example embodiment, the method includes revoking access to the terminal or the access point 110 by dynamically overwriting data to the memory 115 of the NFC tag 120 with the NFC reader and writer 115 in response to the NFC reader and writer 115 reading the NFC tag 120. The NFC reader/writer 115 or the terminal/access point 110 may store data indicating that access for a particular NFC tag is revoked based on the NFC tag id. In response to reading the particular NFC tag id, the NFC reader/writer 115 overwrites the data in the NFC tag to revoke access to the terminal or the access point 110.

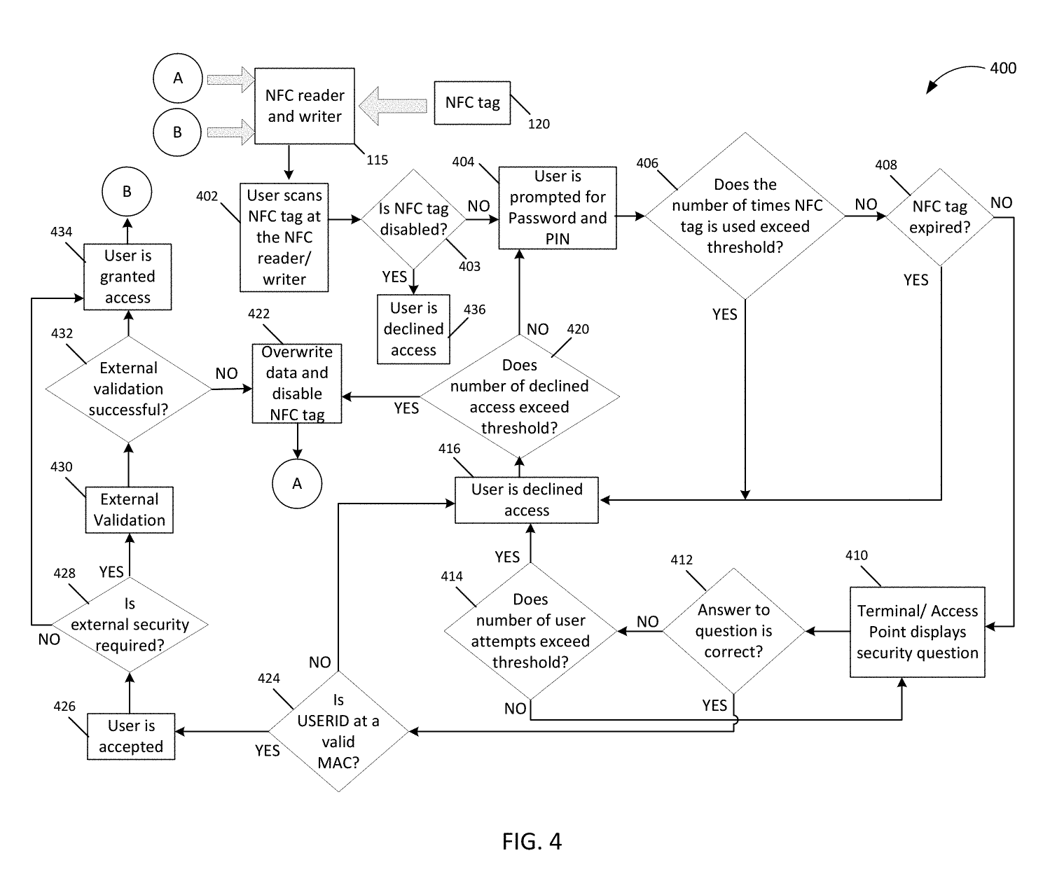

FIG. 4 is a flowchart depicting an exemplary method 400 for using the authentication system described herein, according to an example embodiment. As described above, the authentication system includes the NFC tag 120 and the NFC reader and writer 115. At step 402, the user scans his or her NFC tag 120 at the NFC reader/writer 115. At step 403, the NFC reader/writer 115 checks if the NFC tag 120 is disabled by reading the data stored in the memory of the NFC tag 120, where the data indicates that the NFC tag has been disabled. If the NFC tag is not disabled, then the method continues to step 404. If the NFC tag 120 is disabled, then the method ends at step 436 where the user is declined access to the terminal or access point. As described herein, the NFC tag 120 may be disabled for various reasons, for example, the user's access may be revoked or the user exceeded the number of allowed attempts to authenticate access (such as at step 422). At step 404, the user is prompted to enter a password and/or a PIN at the terminal or the access point.

At step 406, the terminal, the access point or the NFC reader/writer 115 checks if the number of times the NFC tag has been used exceeds a threshold or predefined number. The number of times a NFC tag is used may be stored in the memory of the NFC tag. This value may be updated by the NFC reader/writer 115 by incrementing the value in the memory of the NFC tag each time the NFC tag is scanned at the NFC reader/writer. If the number of times the NFC tag is used exceeds the threshold or predefined number, the method continues to step 416 where the user is declined access to the terminal or the access point.

If the number of times the NFC tag is used does not exceed the threshold or predefined number, then the terminal, the access point or the NFC reader/writer 115 checks if the NFC tag is expired (step 408). The expiration date for the tag may be stored in the memory of the NFC tag. If the tag is expired, then the method continues to step 416 where the user is declined access to the terminal or the access point.

If the tag is not expired, then at step 410 the terminal or the access point displays one or more security questions. The user enters an answer or answers to the security questions. At step 412, the terminal, the access point or the NFC reader/writer checks the answers. The answer to the security question may be stored in the memory of the NFC tag. If the answer(s) is incorrect, then at step 414 the terminal, the access point or NFC reader/writer checks if the number of attempts by the user to answer the question exceeds a threshold or predefined number. If the number of attempts exceeds the threshold or predefined number, then the user is denied access to the terminal or the access point at step 416.

If the number of attempts by the user to answer the question does not exceed the threshold or predefined number, then the method loops back to step 410 where the terminal or the access point displays the security question. Steps 412 and 414 are repeated.

At step 412, if the answer(s) to the security question(s) is correct, then the method continues to step 424. At step 424, the terminal, the access point or the NFC reader/writer checks if the user id is at a valid MAC address. If the user id is not at a valid MAC address, then the user is denied access at step 416. In an example embodiment, some MAC addresses may be locked to restrict access to a physical device. Information regarding a valid MAC address or a range of valid MAC addresses for the user is stored in the memory of the NFC tag. A MAC address is a unique identifier for hardware or a physical device. If the user attempts to log on to a terminal or access point that he or she is not authorized to use, then the user is denied access. That is, if the user attempts to log on to a terminal or access point that does not have a MAC address that is included in the memory of the NFC tag, then the user is denied access to the terminal or access point.

If the user id is at a valid MAC address, then the method continues to step 426 where the user is accepted. At step 428, the terminal, the access point or NFC reader/writer checks if external security is required. In some embodiments, an external security check may be required, for example, the system may perform an Active Directory (AD) validation, a Lighweight Directory Access Protocol (LDAP) validation, RACF® commands, and other security measures that are not included in the NFC tag. If external security is not required, then the user is granted access to the terminal or the access point at step 434. After that, the user cannot use the NFC tag to gain access to the terminal or the access point.

If external security is required, external validation is performed at step 430. In some embodiments, an external security check may be required, for example, the system may perform an Active Directory (AD) validation, a Lighweight Directory Access Protocol (LDAP) validation, RACF® commands, and other security measures that are not included in the NFC tag. If external validation is successful, then the user is granted access to the terminal or the access point at step 434. If external validation fails, then the method continues to step 422 where the NFC reader/writer overwrites data in the memory of the NFC tag and disables the tag. In an example embodiment, the NFC tag 120 includes data bits in memory called one-time programmable (OTP) bits. The NFC tag memory also includes a data bit called a “lock bit” that can be written to once, with a binary value, for example, indicating valid or invalid. If the NFC tag 120 is being disabled, the lock bit is written to indicate “invalid.” In an example embodiment, when the NFC tag 120 is being disabled, all the other non-OTP bits are replaced with low values.

In some embodiments, when the NFC tag is configured for a particular user based on the authentication system described herein, data values are stored in the memory of the NFC tag. At step 422, the data values stored at time of activation are changed to another value when the NFC reader/writer overwrites data in the memory of the NFC tag.

After the user is denied access to the terminal or the access point at step 416, the method continues to step 420 where the terminal, the access point or NFC reader/writer checks if the number of times the user is declined access exceeds a threshold or predefined number. The number of times the user is declined access may be written to the memory of the NFC tag by the NFC reader/writer each time the user is declined access to the terminal or the access point. If the number of times the user is declined access exceeds the threshold or predefined number, then at step 422 the NFC reader/writer overwrites data in the memory of the NFC tag and disables the tag. After that, the user cannot use the NFC tag to gain access to the terminal or the access point. If the number of times the user is declined access does not exceed the threshold or predefined number, then the method loops back to step 404 where the user is prompted to enter a password and/or PIN at the terminal or the access point.

FIG. 5 illustrates a network diagram depicting a system 500 for implementing the authentication system described herein, according to an example embodiment. The system 500 can include a network 505, multiple devices (e.g., a terminal/access point/device 510, a terminal/access point/device 520), a server 530, and database(s) 540. Each of the terminal/access point/device 510, terminal/access point/device 520, server 530, and database(s) 540 may be in communication with the network 505.

In an example embodiment, one or more portions of network 505 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

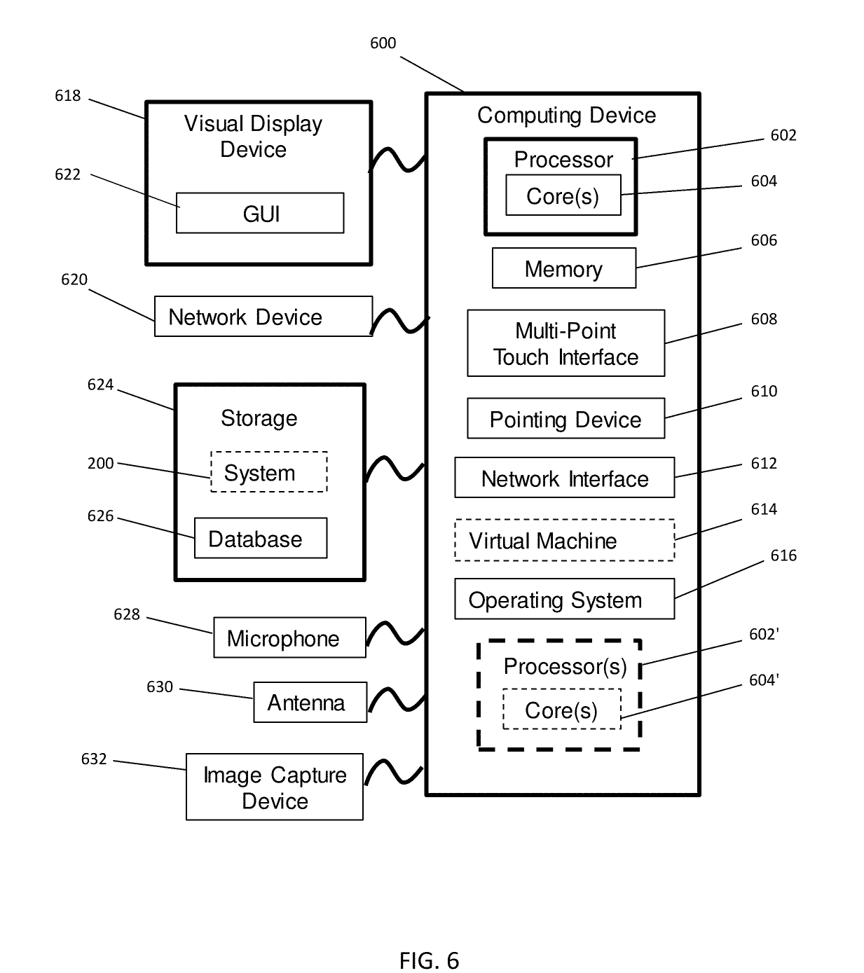

The terminal, access point or device 510 may include, but is not limited to, work stations, computers, general purpose computers, a data center (a large group of networked computer servers), Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, network PCs, mini-computers, and the like. The terminal, access point or device 510 can include one or more components described in relation to computing device 600 shown in FIG. 6. A user may want access to the terminal, access point or device 510, and can gain access via the authentication system described herein. One or more components of the system 200 may be included on the terminal, access point or device 510.

The terminal, access point or device 510 is in wired or wireless communication with a NFC reader/writer 515 (e.g., an RF reader/writer). The NFC reader/writer 515 may be the same as the NFC reader/writer 115 described above. As described, the NFC reader/writer 515 reads data stored in the NFC tag (e.g., and RF tag) or writes data to the NFC tag. The NFC reader/writer 515 is capable of reading data and writing data concurrently or at the same time. In an example embodiment, the NFC reader/writer 515 may include one or more components/modules of the system 200.

Similarly, the terminal, access point or device 520 may include, but is not limited to, work stations, computers, general purpose computers, a data center (a large group of networked computer servers), Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, network PCs, mini-computers, and the like. The terminal, access point or device 520 can include one or more components described in relation to computing device 600 shown in FIG. 6. A user may want access to the terminal, access point or device 520, and can gain access via the authentication system described herein. One or more components of the system 200 may be included on the terminal, access point or device 520.

The terminal, access point or device 520 is in wired or wireless communication with a NFC reader/writer 525. The NFC reader/writer 515 may be the same as the NFC reader/writer 115 described above. As described, the NFC reader/writer 525 reads data stored in the NFC tag or writes data to the NFC tag. The NFC reader/writer 525 is capable of reading data and writing data concurrently or at the same time. In an example embodiment, the NFC reader/writer 525 may include one or more components of the system 200.

The devices 510, 520 may connect to network 505 via a wired or wireless connection. The device 510, 520 may include one or more applications or systems such as, but not limited to, a web browser, applications for the business or organization, an authentication system based on the system 200 described herein, and the like. In an example embodiment, the device 520 may perform some of the functionalities described herein. In an example embodiment, where the NFC reader/writer 515, 525 is embedded in the device 510, 520, the device 510, 520 may authenticate access to the device in the first phase of authentication and the second phase of authentication.

Each of the database(s) 540 and server 530 is connected to the network 505 via a wired or wireless connection. The server 530 may include one or more computers or processors configured to communicate with the devices 510, 520 via network 505. The server 530 hosts one or more applications accessed by the devices 510, 520 and/or facilitates access to the content of database(s) 540. Database(s) 540 may include one or more storage devices for storing data and/or instructions (or code) for use by the server 530, and/or devices 510, 520. Database(s) 540 and server 530 may be located at one or more geographically distributed locations from each other or from devices 510, 520. Alternatively, database(s) 540 may be included within server 530.

FIG. 6 is a block diagram of an exemplary computing device 600 that can be used to perform the methods provided by exemplary embodiments. The computing device 600 includes one or more non-transitory computer-readable media for storing one or more computer-executable instructions or software for implementing exemplary embodiments. The non-transitory computer-readable media can include, but are not limited to, one or more types of hardware memory, non-transitory tangible media (for example, one or more magnetic storage disks, one or more optical disks, one or more USB flashdrives), and the like. For example, memory 606 included in the computing device 600 can store computer-readable and computer-executable instructions or software for implementing exemplary embodiments. The computing device 600 also includes processor 602 and associated core 604, and optionally, one or more additional processor(s) 602′ and associated core(s) 604′ (for example, in the case of computer systems having multiple processors/cores), for executing computer-readable and computer-executable instructions or software stored in the memory 606 and other programs for controlling system hardware. Processor 602 and processor(s) 602′ can each be a single core processor or multiple core (604 and 604′) processor.

Virtualization can be employed in the computing device 600 so that infrastructure and resources in the computing device can be shared dynamically. A virtual machine 614 can be provided to handle a process running on multiple processors so that the process appears to be using only one computing resource rather than multiple computing resources. Multiple virtual machines can also be used with one processor.

Memory 606 can include a computer system memory or random access memory, such as DRAM, SRAM, EDO RAM, and the like. Memory 606 can include other types of memory as well, or combinations thereof.

A user can interact with the computing device 600 through a visual display device 618, such as a touch screen display or computer monitor, which can display one or more user interfaces 619 that can be provided in accordance with exemplary embodiments. The visual display device 618 can also display other aspects, elements and/or information or data associated with exemplary embodiments. The computing device 600 can include other I/O devices for receiving input from a user, for example, a keyboard or other suitable multi-point touch interface 608, a pointing device 610 (e.g., a pen, stylus, mouse, or trackpad). The keyboard 608 and the pointing device 610 can be coupled to the visual display device 618. The computing device 600 can include other suitable conventional I/O peripherals.

The computing device 600 can also include one or more storage devices 624, such as a hard-drive, CD-ROM, or other computer readable media, for storing data and computer-readable instructions and/or software, such as the system 200 that implements exemplary embodiments of the authentication system described herein, or portions thereof, which can be executed to generate user interface 619 on display 618. Exemplary storage device 624 can also store one or more databases for storing suitable information required to implement exemplary embodiments. The databases can be updated by a user or automatically at a suitable time to add, delete or update one or more items in the databases. Exemplary storage device 624 can store one or more databases 626 for storing data used to implement exemplary embodiments of the systems and methods described herein.

The computing device 600 can include a network interface 612 configured to interface via one or more network devices 622 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of the above. The network interface 612 can include a built-in network adapter, network interface card, PCMCIA network card, card bus network adapter, wireless network adapter, USB network adapter, modem or another device suitable for interfacing the computing device 600 to a type of network capable of communication and performing the operations described herein. Moreover, the computing device 600 can be a computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 600 can run operating systems 616, such as versions of the Microsoft® Windows® operating systems, different releases of the Unix and Linux operating systems, versions of the MacOS® for Macintosh computers, embedded operating systems, real-time operating systems, open source operating systems, proprietary operating systems, operating systems for mobile computing devices, or another operating system capable of running on the computing device and performing the operations described herein. In exemplary embodiments, the operating system 616 can be run in native mode or emulated mode. In an exemplary embodiment, the operating system 616 can be run on one or more cloud machine instances.

The following description is presented to enable a person skilled in the art to create and use a computer system configuration and related method and systems for authenticating access to a terminal or an access point. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes multiple system elements, device components or method steps, those elements, components or steps can be replaced with a single element, component or step. Likewise, a single element, component or step can be replaced with multiple elements, components or steps that serve the same purpose. Moreover, while exemplary embodiments have been shown and described with references to particular embodiments thereof, those of ordinary skill in the art will understand that various substitutions and alterations in form and detail can be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods can include more or fewer steps than those illustrated in the exemplary flowcharts, and that the steps in the exemplary flowcharts can be performed in a different order than the order shown in the illustrative flowcharts.

What is claimed is:

1. An authentication system for granting access to an access point, the system comprising:
a Near-Field-Communication (NFC) tag including a memory;
a NFC reader and writer; and
an access point coupled to the NFC reader and writer,
wherein the NFC reader and writer is configured to read the NFC tag when the terminal is activated, and the NFC tag is configured for bisynchronous communication when within a defined physical range of the NFC reader and writer,
wherein, in a first phase of authentication, the NFC reader and writer is configured to read data stored in the memory of the NFC tag and analyze the data to authenticate access to the access point, and
wherein, in a second phase of authentication, the access point is configured to:
receive and analyze a user input, and
grant access to the access point based on the analysis of the user input at the access point and success of the first phase of authentication.

2. The system of claim 1, wherein the NFC tag includes a short-range antenna to facilitate communication with the NFC reader and writer at a specified frequency.

3. The system of claim 1, wherein the NFC tag is configured to be concurrently read and written to.

4. The system of claim 1, wherein the memory of the NFC tag stores a user identification code and an authentication passcode that is read by the NFC reader and writer to authenticate access to the access point in the first phase of authentication.

5. The system of claim 4, wherein the memory of the NFC tag stores a period of time for which the user identification code and the authentication code are valid.

6. The system of claim 1, wherein the NFC reader and writer writes at least one of a number of unsuccessful attempts, a number of successful attempts, or an expiration date to the memory of the NFC tag.

7. The system of claim 6, wherein the NFC reader and writer is configured to erase the data in the NFC tag memory and disable the NFC tag when the number of unsuccessful attempts exceeds a predefined number.

8. The system of claim 1, wherein a server is configured to revoke access to the access point by controlling the NFC reader and writer to dynamically overwrite data to the memory of the NFC tag in response to the NFC tag being read by the NFC reader and writer.

9. The system of claim 1, wherein, in the second phase of authentication, the user input is matched to the data stored in the memory of the NFC tag.

10. The system of claim 1, wherein, in the second phase of authentication, the user input is matched to data stored at a server.

11. A method for authenticating access to an access point, the method comprising:
storing data in a memory of a Near-Field-Communication (NFC) tag, the NFC tag configured for bisynchronous communication when within defined physical range of a NFC reader and writer coupled to an access point;
in a first phase of authentication:
reading, via the NFC reader and writer, the data in the memory of the NFC tag when the access point is activated; and
analyzing the data to authenticate access to the access point;
in a second phase of authentication:
receiving a user input at the access point;
analyzing the user input at the access point; and
granting access to the access point based on the analysis of the user input and success of the first phase of authentication.

12. The method of claim 11, wherein the NFC tag includes a short-range antenna to facilitate communication with the NFC reader and writer at a specified frequency.

13. The method of claim 11, further comprising:
storing a user identification code and an authentication passcode in the memory of the NFC tag that is read by the NFC reader and writer to authenticate access to the access point in the first phase of authentication.

14. The method of claim 13, further comprising:
storing, in the memory of the NFC tag, a period of time for which the user identification code and the authentication code are valid.

15. The method of claim 11, further comprising:
writing at least one of a number of unsuccessful attempts, a number of successful attempts, or an expiration date to the memory of the NFC tag.

16. The method of claim 15, further comprising:
erasing the data in the NFC tag memory and disabling the NFC tag when the number of unsuccessful attempts exceeds a predefined number.

17. The method of claim 11, further comprising:
revoking access to the access point by dynamically overwriting data to the memory of the NFC tag with the NFC reader and writer in response to the NFC reader and writer reading the NFC tag.

18. The method of claim 11, further comprising:
in the second phase of authentication, matching the user input to the data stored in the memory of the NFC tag.

19. The method of claim 11, further comprising:
in the second phase of authentication, matching the user input to data stored at a server.

20. A non-transitory machine readable medium storing instructions that when executed causes a processor to implement a method for authenticating access to an access point, the method comprising:
storing data in a memory of a Near-Field-Communication (NFC) tag, the NFC tag configured for bisynchronous communication when within range of a NFC reader and writer coupled to an access point;
in a first phase of authentication:
reading, via the NFC reader and writer, the data in the NFC tag when the access point is activated; and
analyzing the data to authenticate access to the access point;
in a second phase of authentication:
receiving a user input at the access point;
analyzing the user input at the access point; and
granting access to the access point based on the analysis of the user input and success of the first phase of authentication.
